(19) United States
(12) Patent Application Publication
(10) Pub. No.: US 2005/0004781 A1
(43) Pub. Date: Jan. 6, 2005

(54) System and method for plant management

(75) Inventors: Chuck Price, Matthews, NC (US); Gary Santore, Matthews, NC (US); The Phan, Charlotte, NC (US)

Correspondence Address: Alexander D. Forman;ICE MILLER, One American Square, Box 82001, Indianapolis, IN, 46282-0002, US

(73) Assignee: National Gypsum Properties, LLC, Charlotte, NC (US)

(21) Appl. No.: 10/828,751

(22) Filed: Apr. 21, 2004

Related U.S. Application Data
(60) Provisional application No. 60/464,461, filed on Apr. 21, 2003.

(51) Int. Cl. G06F 19/00

(52) U.S. Cl. 702/188; 700/108

(57) ABSTRACT

A system and method for plant management that generates real time reports and eliminates the heavy reliance on IT personnel to analyze data. A system and method that eliminates the multiple data entry points and the use of multiple databases for the storing of manufacturing process data. A system and method that can easily and quickly be customized to any manufacturing plant and that enables plant personnel to configure customized views of the collected data. A system and method that that can be tailored to focus on certain specifications to ensure that plant personnel are alerted in real time if the manufacturing process is producing products that do not meet those specifications.

### CROSS REFERENCE TO RELATED APPLICATION

This application claims the benefit of U.S. Provisional Patent Application No. 60/464,461, filed Apr. 21, 2003.

### BACKGROUND OF INVENTION

Manufacturers have long sought tools to help gather, manipulate and analyze data from its manufacturing processes. Such data can be useful in preventing costly breakdowns of the manufacturing equipment and can help prevent faulty products from being produced. Further, in relation to manufactured products that have to meet certain specifications before they can be sold, it is imperative for manufacturers to continually monitor produced products and the manufacturing process to ensure that the specifications are actually being met. As one can imagine, if a faulty manufacturing process or a malfunctioning piece of equipment goes undetected, then the manufacturer will have products that fail to meet the required specifications. Thus, the longer a faulty process or equipment remains undetected, the more resources, time and money is being wasted.

To address this concern, certain monitoring equipment and systems have been developed to gather data that can be useful in preventing such malfunctions from occurring. For example, programmable logic controllers (“PLCs”) and human machine interfaces (HMIs) have been developed to monitor and control manufacturing equipment and processes. A PLC can be programmed to monitor and control a specific measure (i.e. flow rate) of a manufacturing process. For example, if a manufacturing process requires a flow rate of 5 gallons per minute of material, then the PLC can be programmed to continually monitor the flow rate of the process. In the event the flow rate ceases to be meet this 5 gallons per minute target, the PLC an be programmed to take adjustments to bring the process back into compliance. HMIs identify a computer system that enables a user to view the data collected by the PLC and enables the user to communicate with the PLC. Thus, in our example, if a user desires to decrease or increase the flow rate, the user can use the HMI to instruct the PLC to do so. This data collected by the PLCs and HMIs is usually automatically stored in a database for a certain duration of time.

Manually collected data is also collected by plant personnel. Plant personnel perform tests in labs and on plant floors to determine if the manufactured products meet the required specifications. The analysis of this data is also useful in determining if a manufacturing process is faulty and/or if manufacturing equipment is malfunctioning. Further, the analysis of this data can also help determine measures that can be taken to fix the process or equipment. This data is stored in a separate database from the PLC and HMI database.

If they have the proper tools, manufacturers realize that the data collected by the PLCs and HMIs can be analyzed in conjunction with the manually collected data from tests to determine if the products are meeting the desired specifications. Current methods use systems interfaces, redundant data entry and multiple user interfaces to analyze process, test and statistical data. Thus, vital information is not immediately accessible to the manufacturer's personnel in real time on the plant floor and cannot be used to immediately alert the plant personnel when the products do not meet the specifications. Thus, such a system and method are not useful in preventing the production of products not meeting the desired specification, because the system and method does not provide real time data to the plant personnel.

Thus, among other things, it is desired to have a system and method that generates real time views of information and eliminates the heavy reliance on information technology (“IT”) personnel to build customized system for each plant facility. It is further desired to have a system and method that eliminates the multiple data entry points (i.e. the entry of PLC and HMI collected data in one database and the entry of test data into a separate database) and that eliminates the use of multiple databases for the storing of manufacturing data (i.e., use of one database for the collection of PLC and HMI data, use of another database for test data entry, and the use of a third database for statistical processing). Moreover, it is desired to have a system and method that can easily and quickly be customized to any manufacturing plant and that enables plant personnel to configure customized views of the plant manufacturing process data It is also desired to have a system and method that can be tailored to focus on certain specifications of the product and that alerts the plant personnel in real time when manufacturing process is producing products that do not meet those specifications.

### BRIEF INVENTION SUMMARY

The present invention provides a method and system for managing and measuring the performance of any manufacturing plant or any set of manufacturing plants through the collection and analysis of manufacturing data. The method and system provides data in real time to an end user (i.e., plant personnel) and can be easily customized to any manufacturing plant and its products and processes. This system and method provides an end user with a means for creating customized reports and views of the data without relying on IT personnel. The system and method interfaces directly with a database in order to access the stored data and does not require multiple database, multiple points of data entry or the transfer of data.

An embodiment of the present invention comprises a method of and system for plant management. This embodiment collects and stores pieces of data from a manufacturing sub-process on a single database through a data collecting apparatus. This embodiment utilizes a key process indicator dashboard (“KPI dashboard”) with a statistical process control subsystem (“SPC subsystem”) to access the pieces of data stored on a single database. A user of the KPI dashboard can set a range of specifications (i.e., a range of values that the data needs to fall within) for each piece of data that is collected. The SPC subsystem will notify the user of the KPI platform in real time when the value of the piece of data falls outside the range of the specifications. The data collecting apparatus can comprise a PLC, a HMI and/or a quality data entry subsystem (QTDE subsystem). The QTDE subsystem can contain a plurality of data entry sheets that allow for the manual entry of test data directly into the single database. Thus, this embodiment eliminates the multiple data entry points through the collection of the PLC data, the HMI data and the data manually entered through the QTDE subsystem in the single database.

The KPI platform along with its corresponding Ad Hoc Reporting subsystem and SPC subsystem can generate customizable real time reports for users (i.e., plant personnel). The KPI platform can comprise a plurality of screens that allow the user to customize the platform to the specific plant, manufacturing process and the product produced. For example, it allows an end-user to set alarms and specification values for each product and measure through the Update Alarms and Specifications screen and allows an end-user to input information specific to the plant and the manufactured products through the Product and Information screen.

### BRIEF DESCRIPTION OF THE DRAWINGS

FIG. 1 shows a diagrammatic view of an exemplary embodiment of a plant management system that includes an ADC dashboard;

FIG. 2a shows a screen shot of the ADC dashboard dropdown menu positioned on a toolbar;

FIG. 2b shows a screen shot of this embodiment's main KPI dashboard that can be accessed through the ADC dashboard dropdown menu of FIG. 2a by selecting the “Main Dashboard” tab;

FIG. 3 shows a screen shot of an Alarms Summary screen that can be accessed through the ADC dashboard's dropdown menu of FIG. 2a by selecting the “Alarms Summary” tab;

FIG. 4a shows a screen shot of an Alarms and Specifications screen that can be accessed through the ADC dashboard dropdown menu of FIG. 2a by selecting the “Update Alarms and Specs” tab;

FIG. 4b shows a screen shot of the View All Alarms and Specifications screen that can be accessed through the ADC dashboard dropdown menu of FIG. 2a by selecting the “View all Alarms and Specs” tab;

FIG. 5 shows a screen shot of the Product and Plant Information screen that can be accessed through the ADC dashboard dropdown menu of FIG. 2a by selecting the “Plant Information and Setup” tab;

FIG. 6 shows a screen shot of the Analysis Report that can be accessed through the ADC dashboard dropdown menu of FIG. 2a by selecting the “Analysis” tab;

FIG. 7 shows a screen shot of the Three Tag Correlation Report that can be accessed through the ADC dashboard dropdown menu of FIG. 2a by clicking on the “Three Tag Correlation Report” tab;

FIG. 8 shows a screen shot of the Workbench Report that can be accessed through the ADC dashboard dropdown menu of FIG. 2a by clicking on the “Workbench” tab;

FIG. 9 shows a screen shot of a Board Profile screen that can be accessed through the ADC dashboard dropdown menu of FIG. 2a by clicking on the “Board Profile” tab;

FIG. 10 shows a screen shot of the SPC module that can be accessed through the ADC dashboard dropdown menu of FIG. 2a by clicking on the “Statistics” tab;

FIG. 11a shows a screen shot of a Reasons and Actions pop-up window that can be accessed through the SPC module of FIG. 10 by clicking on an out-of-control button;

FIG. 11b shows the Reasons and Actions pop-up window of FIG. 11a with inputted data in the window;

FIG. 12 shows a print-out of a sample Best Practices Guide that can be accessed through the Reasons and Actions pop-up window by clicking on the “Best Practices Guide” button;

FIG. 13 shows a log-in screen for the SPC Quality Reporting subsystem of the SPC module;

FIG. 14 shows a screen shot of the main menu for the SPC Quality Reporting subsystem;

FIG. 15 shows a sample Monthly Quality Report generated by the SPC Quality Reporting subsystem by clicking on the “Monthly Quality Report” button on the main menu shown in FIG. 14;

FIG. 16 shows a screen shot of a Monthly Board Weight Report generated by the SPC Quality Reporting subsystem by clicking on the “Monthly Board Weight Report” button on the main menu shown in FIG. 14;

FIG. 17 shows a screen shot of a Product Data screen generated by the SPC Quality Reporting subsystem by clicking on one of the “Set-Up” buttons on the main menu shown in FIG. 14;

FIG. 18a shows a screen shot of a Product Detail Report screen generated by the SPC Quality Reporting subsystem by clicking on one of the “Product Detail” buttons on the main menu shown in FIG. 14;

FIG. 18b shows a screen shot of the 3-month rolling average and 3-month period ending sections of the Product Detail Report screen of FIG. 18a;

FIG. 18c shows a screen shot of the current year-to-date and monthly averages sections of the Product Detail Report screen of FIG. 18a;

FIG. 19 shows a screen shot of the top level screen for the Ad Hoc Reporting subsystem;

FIG. 20a shows a screen shot of both the date and time dropdown menus of the top level screen of FIG. 19;

FIG. 20b shows a screen shot of the plant dropdown menu of the top level screen of FIG. 19;

FIG. 20c shows a screen shot of the select period/frequency dropdown menu of the top level screen of FIG. 19;

FIG. 20d shows a screen shot of the server select dropdown menu of the top level screen of FIG. 19;

FIG. 20e shows a screen shot of one of the measure dropdown menus of the top level screen of FIG. 19;

FIG. 21 shows a screen shot of a Dry End Manual Data Entry screen of the QTDE subsystem that is a part of the plant management system of FIG. 1;

FIG. 22 shows a screen shot of a Mill Manual Data Entry screen of the QTDE subsystem;

FIG. 23 shows a screen shot of a Wet End Manual Data Entry screen of the QTDE subsystem;

FIG. 24 shows a screen shot of a Knife Manual Data Entry screen of the QTDE subsystem; and

FIG. 25 shows a screen shot of a Lab Manual Data Entry screen of the QTDE subsystem.

### DETAILED DESCRIPTION OF THE INVENTION

FIG. 1 shows a diagrammatic view of an exemplary embodiment of a plant management system 10. In this embodiment, plant management system 10 is utilized to manage and monitor several manufacturing sub-processes for the production of wallboard products. As shown in FIG. 1, the system 10 has manufacturing equipment 14 electronically and operatively connected to several programmable logic controllers (PLCs) 12 by means well known in the art, (i.e., sensors and wires). PLCs 12 can be programmed to measure and collect any type of data from the manufacturing equipment 14 and the manufacturing sub-process being performed. For example, PLC's 12 can be programmed to measure and collect line speeds, temperatures, feed rates, flow rates, pressure, density, moisture, machine speed, motor speed, weight, motor amps, viscosity, width, length, and caliper measurements. PLCs 12 are electrically and operatively connected to a series of human machine interfaces (HMIs) 16 and a plant database 28 by means well known in the art (i.e. cables 18). HMIs 16 can comprise a series of computers connected to one another in a network. It will be appreciated that electrically and operatively connected includes any number of means of connecting electronics together known in the art including, but not limited to, a network or wireless communication. Further, it will be appreciated that plant database can comprise any type of database known in the art, including a relational database or customized high speed storage database. These HMIs 16 allow users to monitor, control and collect data from PLCs 12. Each of the PLCs 12 and HMIs 16 monitor, measure and collect data relating to a specific and separate manufacturing sub-process that is being performed in the plant. The collected data is then transferred to and stored in plant database 28. This stored data can then be used by users to relate an end-product to each stage of its manufacturing sub-process.

Still referring to FIG. 1, HMIs 16 are connected to a process information isolation switch 20 and a plant router 22 that allows the plant to access both data local to the plant, as well as, data from other plants connected to the process information isolation switch. Plant router 22 can be electronically connected by a hi-speed phone line 25, or other like means known in the art, to another router 24 that allows a central repository, such as a database 26 at a corporate office, to store the data collected by all the PLCs 12 and/or HMIs 16 in several different plants. Both the plant database 28 and the corporate database 26 are electronically connected to a plant ADC dashboard 30 and a corporate ADC dashboard 32, respectively. The ADC dashboard can reside on any type of computer or local file server and acts as an interface to the database. In one embodiment, the dashboard comprises a Microsoft Excel add-in that can be coded to act as the ADC dashboard. The plant ADC dashboard 30 provides a system that allows a user to view and analyze the data for the specific plant. The corporate ADC dashboard 32 provides a system that allows a user to view and analyze data for a specific plant or for a consolidated corporate view of multiple manufacturing facilities. While dashboards 30 and 32 are located in different locations, they are virtually identical and are used primarily for the same purposes.

For ease of the reader, the detailed description of the ADC dashboard focuses on the plant ADC dashboard 30. However, it will be appreciated that this discussion is equally applicable to the corporate ADC dashboard 32. Focusing on the plant ADC dashboard 30, the dashboard provides access to a configurable key process indicator dashboard (“KPI”) 40, a Ad Hoc Reporting subsystem, a statistical process control subsystem (“SPC subsystem”) with a statistical process control module (“SPC module”) 36, and a SPC Quality Report subsystem. Further, the ADC dashboard 30 is connected to a network with the plant database 28 and a quality test data entry subsystem (“QTDE subsystem”) 38.

FIG. 2a shows this embodiment's toolbar 11 with the ADC dashboard dropdown menu 48. As used herein, a “dropdown menu” is a menu that allows the user to highlight and select one of several defined choices. When a user clicks on the dropdown menu 48, a list of all the screen tabs associated with the ADC dashboard will be displayed. Dropdown menu 48 has a “Main Dashboard” tab 39 that will take a user to main KPI dashboard 40. FIG. 2b shows a screen shot of this embodiment's main KPI dashboard 40. The KPI dashboard does not require a separate database structure or the creation of data transfer files to access the plant database. KPI dashboard 40 allows the user of plant management system 10 to directly access the plant database 28 and configure and manipulate the data stored therein. This data could be the data collected by the PLCs 12 and/or HMIs 16 (shown in FIG. 1) and could also include quality test data gathered from the physical testing of in-process and end-product attributes entered into the plant database through the QTDE Module 38, as described below.

As shown in FIG. 2b, KPI dashboard 40 comprises two date selection dropdown windows 42 and a manufacturing sub-process selection field 54. Field 54 contains several manufacturing sub-process radio buttons 55 that allow the user to select a specific manufacturing sub-process for which the user would like to see data. The user can change the title of the manufacturing sub-process radio button 55 by typing over the current name. After selecting the desired manufacturing sub-process radio button 55, a plurality of individual measures 44 will appear in a performance measure field 45. Each of these measures 44 are associated with a dropdown arrow 57 and a corresponding measure button 122. By clicking on dropdown arrows 57, the user will be presented with all the measures being collected and will be able to select the desired measure by highlighting it. For example, in this embodiment, the user has selected the “kiln Temp/Moist” manufacturing sub-process in field 54 and the user has selected seven corresponding measures 44 in performance measure field 45 (i.e., zone #1 inlet stem temp.; zone #1 exit stem temp, etc.) utilizing dropdown arrows 57. Of course, the user can change, delete or add measures 44 at any time by clicking on dropdown arrows 57.

In this embodiment, up to six manufacturing sub-process radio buttons 55 are available from which to select in field 54 and up to twelve measures 44 are allowed to be defined for each manufacturing sub-process radio button. While this embodiment allows up to six manufacturing sub-process radio buttons 55 to be defined in field 54 and allows twelve different measures 44 to be defined for each sub-process, the KPI dashboard 40 can be programmed to define any number of manufacturing sub-processes and measures associated with those sub-processes. Moreover, for larger more complex manufacturing sub-processes, multiple KPI dashboards may be used for a plant by an individual user of the system.

Date selection menus 42 allow the user to select two days of interest at once for review by utilizing the corresponding dropdown arrow 57. These two dates can be consecutive or non-consecutive days. While this embodiment provides two date selection menus 42, the KPI dashboard 40 can be configured to show any number of date selection menus. When the manufacturing sub-process and the dates are selected, KPI dashboard 40 pulls all of the data from plant database 28 (shown in FIG. 1) for the selected measures 44 for the selected dates. The KPI dashboard 40 then compares those measures 44 to a set of defined alarm or warning specifications. KPI dashboard 40 then calculates and displays the total number of times that these measures of the selected manufacturing sub-process exceeded or did not reach the desired specifications (i.e. an alarm) for each measure 44. In this embodiment, the KPI dashboard 40 displays the number of alarms for each measure 44 in three different columns 41. Columns 41 refer to a specific manufacturing shift (i.e., first, second and third shifts). To view the details regarding the alarms, the user can click on the alarm buttons 53 to receive more information about each alarm. This will transfer the user to an Alarms Summary screen.

Referring to FIG. 2a, a user can also access the Alarms Summary screen by selecting the Alarms Summary tab 79 from dropdown menu 48. FIG. 3 shows a screen shot of an Alarms Summary screen 80. The Alarms Summary screen 80 provides analysis for alarm conditions that occurred during the selected day. As shown in FIG. 3, the Alarms Summary page provides a radio button 82 for each shift that allows a user to select a specific shift for which a user desires to see an alarm summary. If a user accesses screen 80 by clicking on one of the alarm buttons 41, then a shift will automatically be selected. This shift can be changed by selecting a different radio button 82. In this embodiment, the Alarms Summary screen 80 displays a list 84 of all the alarms. This list 84 provides the date and time the alarm occurred, the value of the measure that caused the alarm, and the product code that identifies the product being analyzed. A user can use a scroll bar 85 to scroll through the individual values of the list. The Alarms Summary screen 80 also shows a histogram 86 that groups the values of the measures from the minimum values to the maximum values.

The Alarms Summary screen 80 also displays an alarms summary chart 88 with the value of the selected measure 44 from the KPI dashboard 40 on the y-axis and the time and date on the x-axis. The alarms summary chart 88 has a line A that corresponds to the value of the low alarm setting and a line B that corresponds to the value of the high alarm setting. The values of the low and high alarm settings and the total number of alarms that occurred during this shift are displayed in field 87. Anything that does not fall within this high and low alarm range is plotted as a point 83 on the chart 88 to summarize the alarm. A user of this screen can use a hide/show product code button 89 in order to display or hide the product code of the product being manufactured.

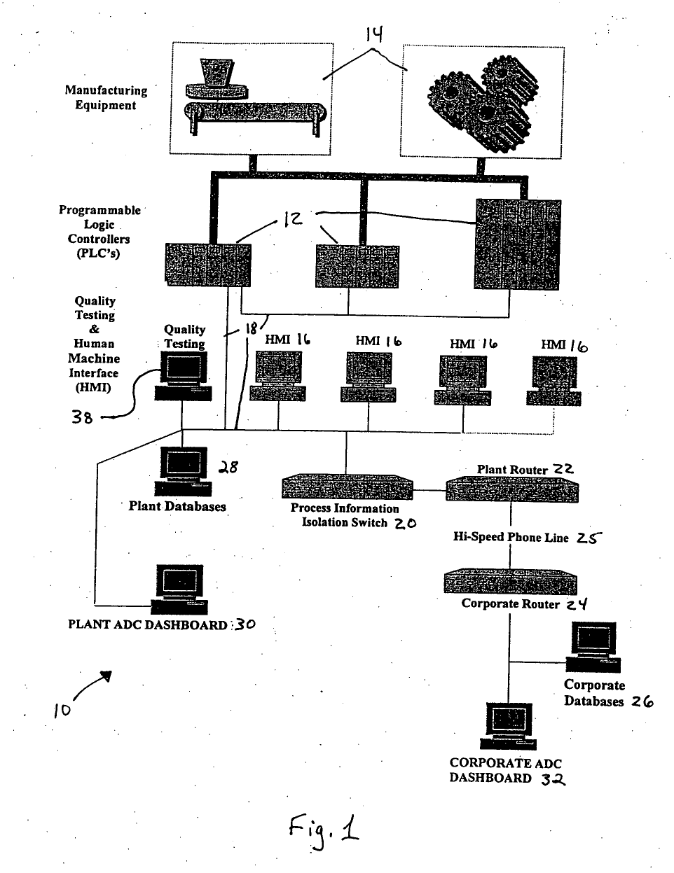

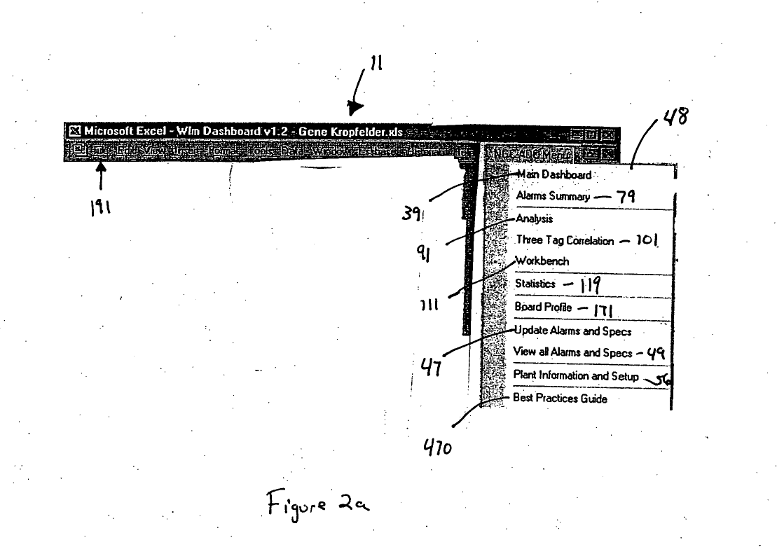

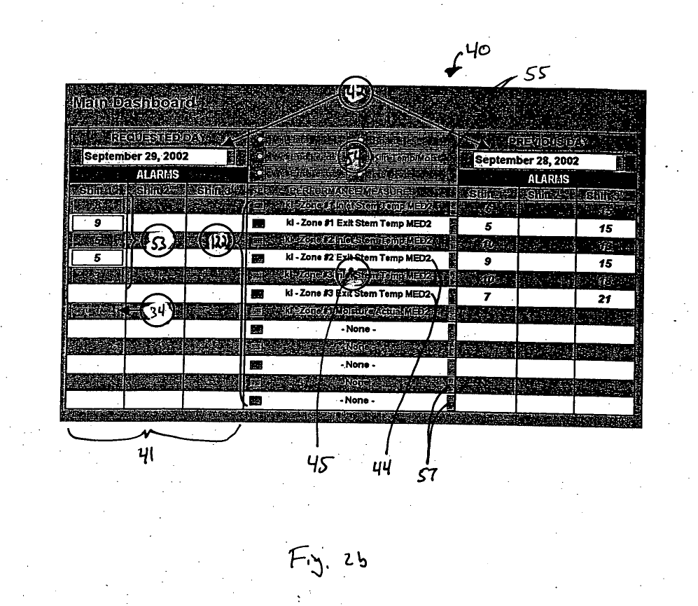

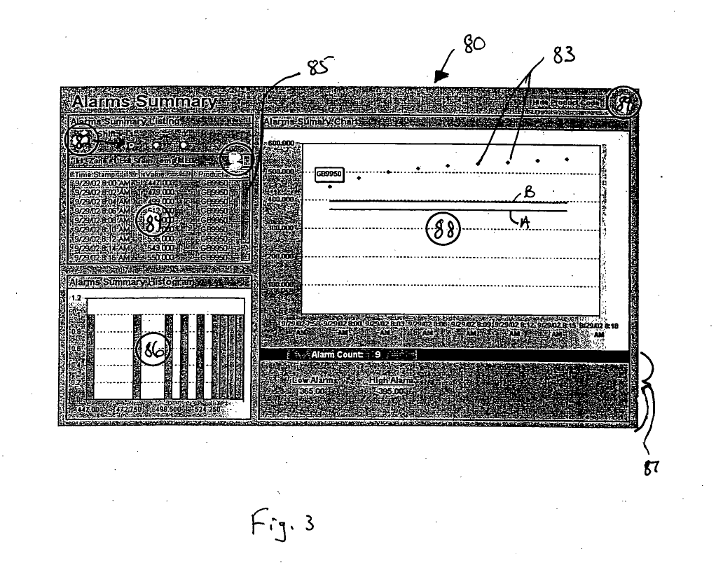

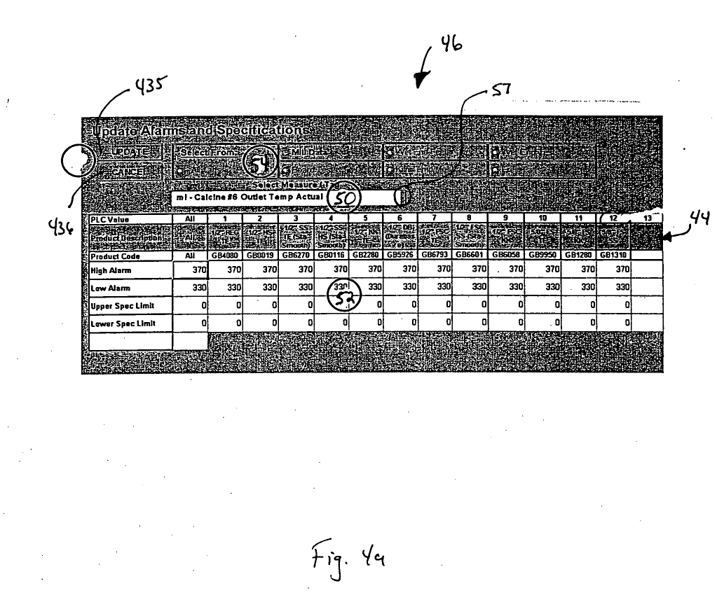

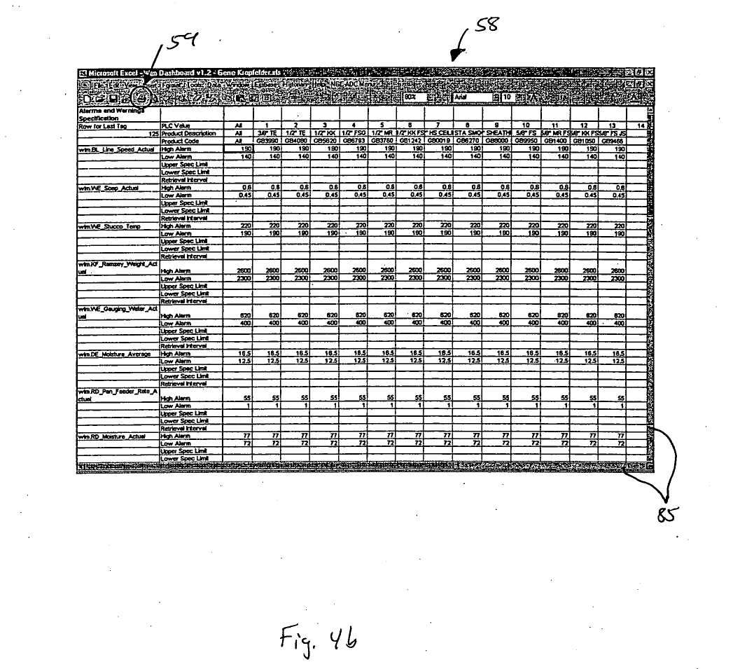

FIG. 4a shows a screen shot of an Alarms and Specifications screen 46. As shown in FIG. 4a, Alarms and Specifications screen 46 allows a user to define the range of the values for the alarms and specifications. As used herein, the term “specification” refers to the values of a measure of a product that must not be exceeded or that must be exceeded for the user to be able to sell the product (i.e. a regulatory specification or a customer specification). As used herein, the term “alarm” refers to the values of a measure of a product that are close to and fall within the range of the values of the specification, so that when the alarm values are reached, the user will be notified that the measure is close to the specifications. Referring to FIG. 2b, if specifications have not been set for a particular measure 44 on the KPI dashboard, a setup target button 34 will appear on the KPI dashboard. In this embodiment, the Alarms and Specifications screen 46 can be accessed by pressing the setup target button 34 on the KPI dashboard 40 or if alarms and specifications have been set for each measure, by selecting the “Update Alarms and Specs” tab 47 from the dropdown menu 48 (shown in FIG. 2a).

Referring to FIG. 4a, like main KPI dashboard 40, the Alarms and Specifications screen 46 has a manufacturing sub-process selection field 54 that allows the user to select the specific manufacturing sub-process for which it desires to configure alarms and specifications. Further, the Alarms and Specifications 46 screen has a measure menu 50 with corresponding dropdown arrow 57 that allows a user to select one of the twelve measures 44 selected by the user on the KPI dashboard 40 (show in FIG. 2b). Once a user selects one of the measures in menu 50, the user can configure alarms and specifications for that measure in a data entry area 52. For example, FIG. 4a shows that the user has selected the Mill sub-process data tab from the field 54 and has selected the “Calcine #6 Outlet Temp” measure from the menu 50. After selecting these two items, the user is allowed to set a high and low alarms and an upper and lower specification limits for that component of the manufacturing sub-process. The user can update/store the alarm data by hitting update button 435 or cancel and return to KPI dashboard 40 by clicking cancel button 436.

Referring back to FIG. 2a, dropdown menu 48 also has a “View all Alarms and Specs” tab 49 that provides access to a View All Alarms and Specification screen 58. FIG. 4b shows a screen shot of the View All Alarms and Specification screen 58. As shown in FIG. 4b, sheet 58 displays the high and low alarms and the upper and lower specification limits that have been set by the user for each product. This screen allows the user to scroll up and down and side-to-side using two scroll bars 85, and allows the user to print the screen 58 by clicking on printer icon 59.

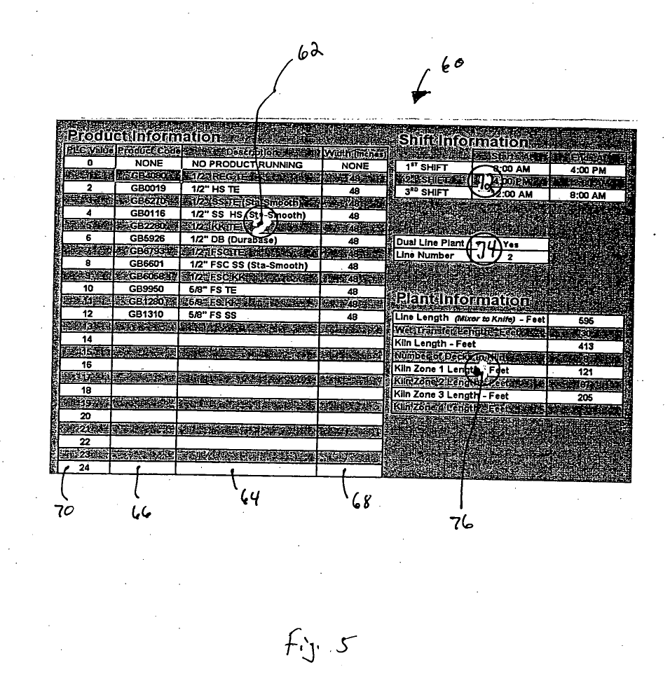

Referring back to FIG. 2a, the dropdown menu 48 also has a “Plant Information and Setup” tab 56. Upon selecting tab 56, a user is transferred to a Product and Information screen 60. FIG. 5 shows a screen shot of the Product and Plant Information screen 60. Screen 60 is used to define the key attributes needed to tailor the system to a specific plant's operation. As shown in FIG. 5, information regarding the products manufactured by the plant can be entered and displayed in a product information field 62. In this embodiment, field 62 can contain information for up to one hundred products. Such information is split into a product description column 64, a product code column 66, a width column 68 and a PLC value column 70. The product description column 64 identifies the product being manufactured and the product code column 66 lists the corresponding product/catalog code for that product. In this embodiment, the PLC value column 70 identifies the specific PLC collecting data for the manufacturing sub-process that produces that product. While field 62 of this embodiment is programmed to provide a product description, a product code, a PLC value and the width for up to one hundred products, field 62 can be programmed to provide any information desired by the user and can be programmed to store information for any number of products.

Still referring to FIG. 5, the Product and Plant Information screen 60 also contains a shift information field 72 that provides the start time and end time for each shift. Further, screen 60 contains a line configuration field 74 that indicates the appropriate line number for the products listed and whether or not the plant has dual lines. Screen 60 also has a plant information field 76 that allows the user to define the physical dimensions of the equipment that moves material between the manufacturing sub-processes. By providing these fields in screen 60, this embodiment allows the KPI dashboard 40 to be configured for any plant and be used to correlate data from multiple manufacturing sub-processes at once. This capability allows a finished product to be time traced through every step of the manufacturing process.

Three distinct types of process run charts for the selected sub-process can be automatically generated for any selected measure 44 or set of measures 44 (shown in FIG. 2b). Referring to FIG. 2a, dropdown menu 48 allows a user to access one of these three run charts by selecting either the “Analysis” tab 91, the “Three Tag Correlation” tab 101, or the “Workbench” tab 111.

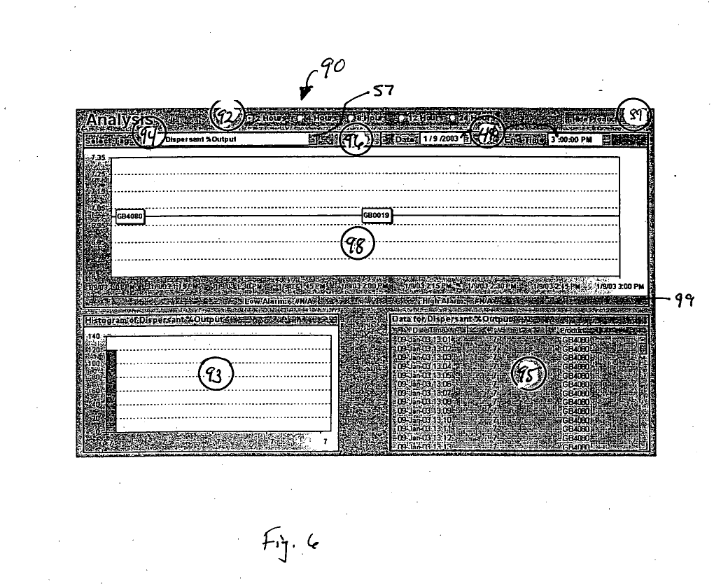

FIG. 6 shows a screen shot of the Analysis Report 90. As shown in FIG. 6, the Report 90 is a run chart for a single selected measure. Once the user has accessed the Analysis Report 90, the user can select a measure to be charted and a time frame to chart the selected measure. In this embodiment, by selecting one of the radio buttons 92, the user can choose a two hour, four hour, eight hour, twelve hour or twenty-four hour view of a selected measure of interest. The user can also use the measure menu 94 and corresponding dropdown arrow 57 to select the desired measure to be charted. Menu 94 lists all of the measures stored in the plant database. After selecting the measure from menu 94 and the radio button 92 associated with the desired time frame, Report 90 will be generated. User can also use dropdown menus 440 to select the date and end time for the report, as well as use, Hide/Show Product button 89, to hide the product code.

Still referring to FIG. 6, Report 90 generates a chart 98 on an x and y-axis. The x-axis displays the date and time and the y-axis displays the value of the measure. Chart 98 also displays the high and low alarm settings in field 99 and allows the user to move forward and backward in time by utilizing the time scroll buttons 96. A histogram 93 is also created that shows the value of the measure from the minimum to the maximum value. Report 90 also generates a scrollable list 95 that displays the date and time the measure was taken, the value of the measure, and the product code for the product measured.

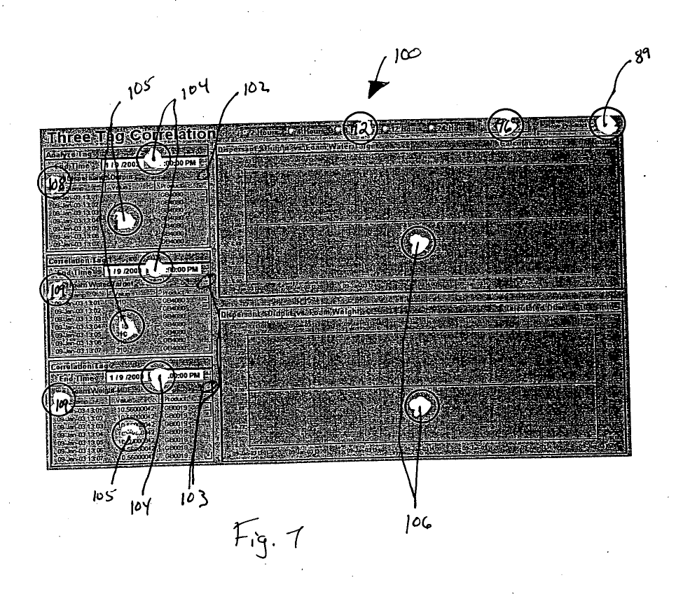

FIG. 7 shows a screen shot of the Three Tag Correlation Report 100. Report 100 allows a user to view the run charts for three related measures or allows a user to view the run charts for the same measure over three different time frames. Report 100 also provides radio buttons 92 that allow the user to select from a time period of two, four, eight, twelve, and twenty-four hours, hide/show product button 89, and provides time scroll buttons 96 that allow the user to move forward and backward in time. Report 100 has a main measure field 108 with a dropdown measure menu 102 and two secondary measure fields 109 each with a dropdown measure menu 103. Menu 102 allows the user to select a main measure that will be charted and compared to the two measures selected through menus 103. Fields 108 and 109 each have time stamp windows 104. The time stamp windows 104 of fields 109 will automatically be synchronized with the time selected in time stamp windows 104 in field 108. However, the individual time stamp windows 104 will allow the user to override the automatic synchronization of the selected time frame so that each field can have a different selected time frame. Report 100 also generates a scrollable list 105 in fields 108 and 109 that displays the date and time the measure was taken, the value of the measure taken, and the product code of the product from which the measure was taken. Report 100 also generates two charts 106 on an x and y-axis that compare the main measure of field 108 individually with the other two selected measures of fields 109. The x-axis lists the date and time and the y-axis lists the value of the measures.

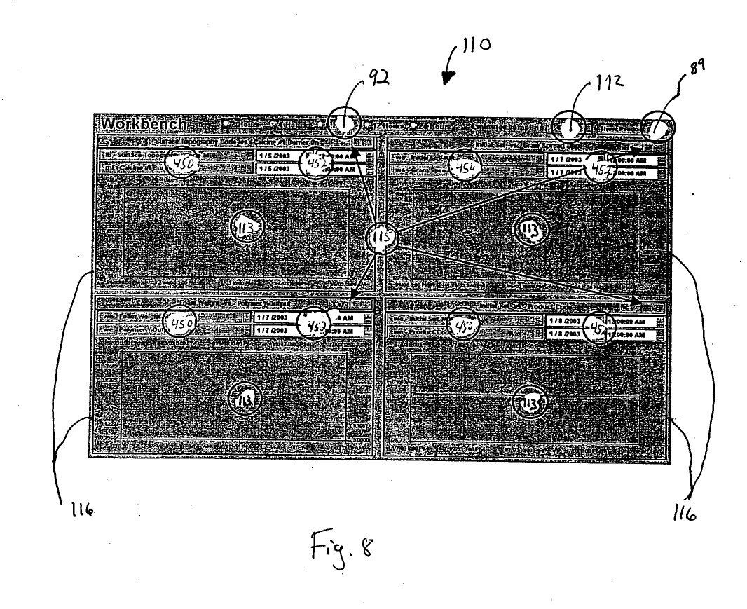

FIG. 8 shows a screen shot of the Workbench Report 110. Workbench Report 100 allows the user to select up to eight separate measures of interest from dropdown menus 450. If desired, the user can select the same measure, instead of different measures, in menus 450 for charting over four different time periods. Report 110 provides eight separate time and date stamps 452 that allow the user to select the desired time and date for each measure. As shown in FIG. 8, Report 110 also provides: buttons 92 that allow the user to select from a time period of two, four, eight, twelve, and twenty-four hours; hide/show product button 89; and scroll buttons 112 that allow the user to scroll backwards and forwards through the data on all the produced charts. Four different charts 113 are produced by Report 110 in fields 116. Each field 116 has two dropdown measure menus 450 that allow the user to select two measures to be compared to one another or a single measure to be compared over two different time frames. Further, each field 116 also has two end time stamp windows and date stamp windows 452 that allow the user to select the end time and date for each selected measure in menu 450 independently of the other measure. Each chart 113 has an x-axis that displays the date and time when the measure was taken and a y-axis that displays the value of the measures. Each chart 113 also has its own scroll buttons 115 that allow the user to move each chart separately backward and forward in time.

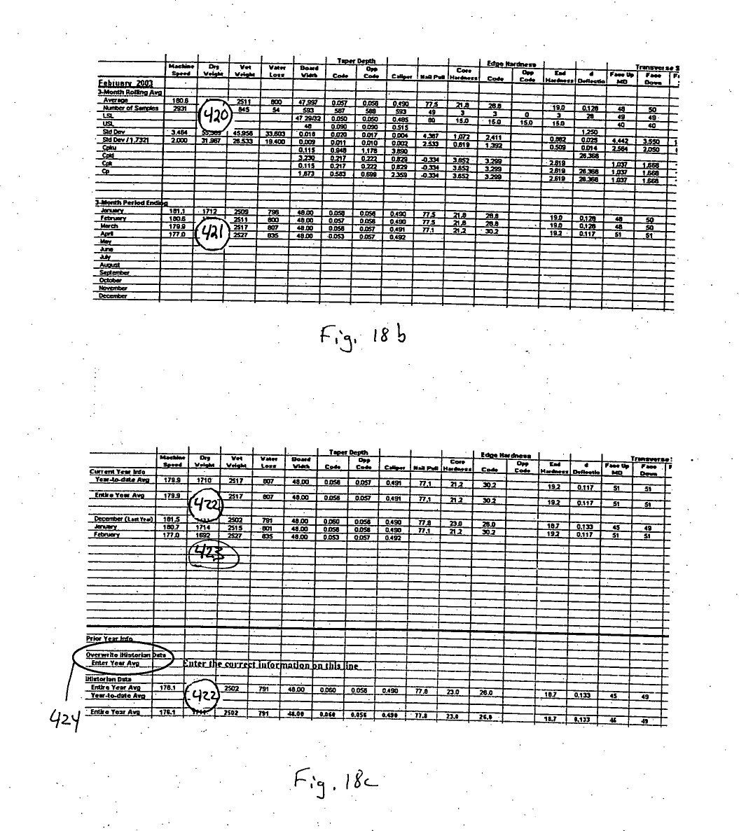

Plant management system 10 also allows the user to generate custom reports. FIG. 19 shows a screen shot of the top level screen 250 for an AD Hoc Reporting subsystem of plant management system 10. The subsystem can be accessed by clicking on a shortcut that is located on a desktop or laptop computer. The subsystem allows the user to configure customized reports of the plant data and information stored in the plant database 28 without having any knowledge of the underlying database design or programming skills. Such reports can replace manual logs or support process analysis.

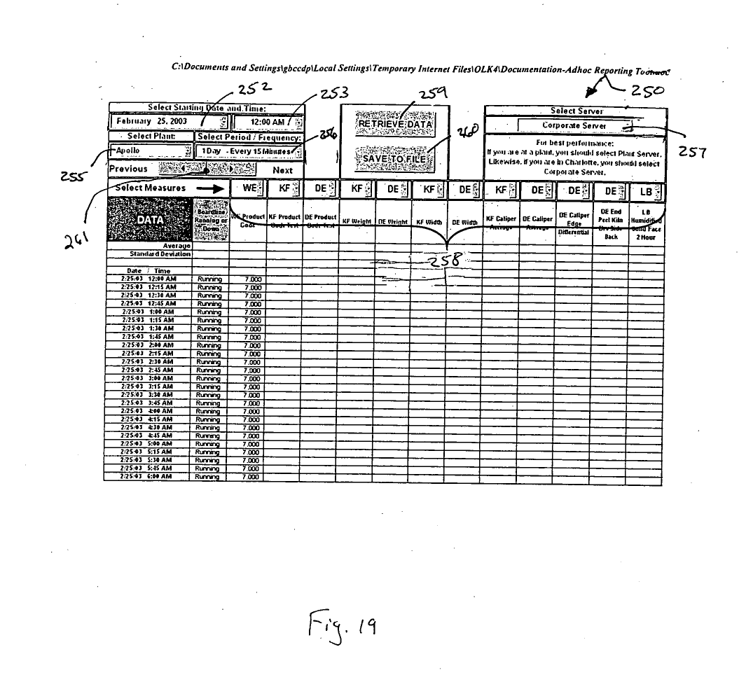

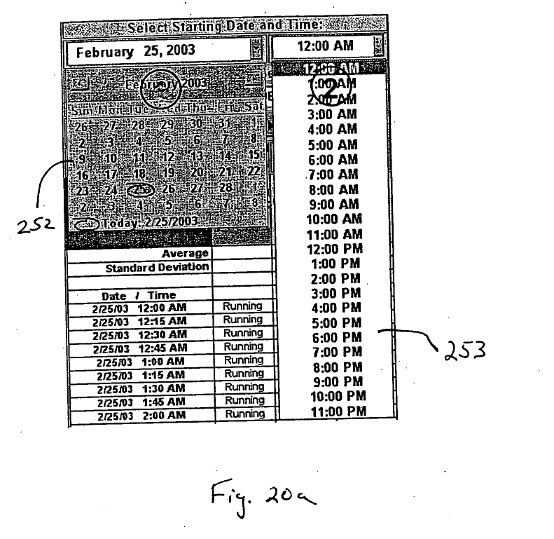

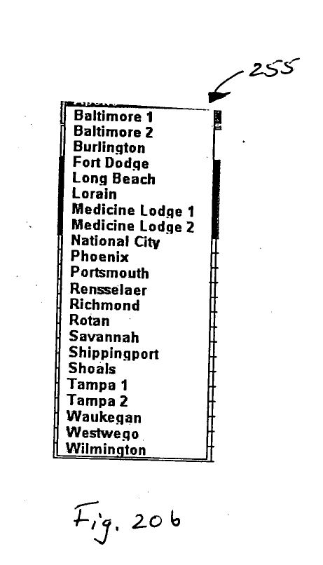

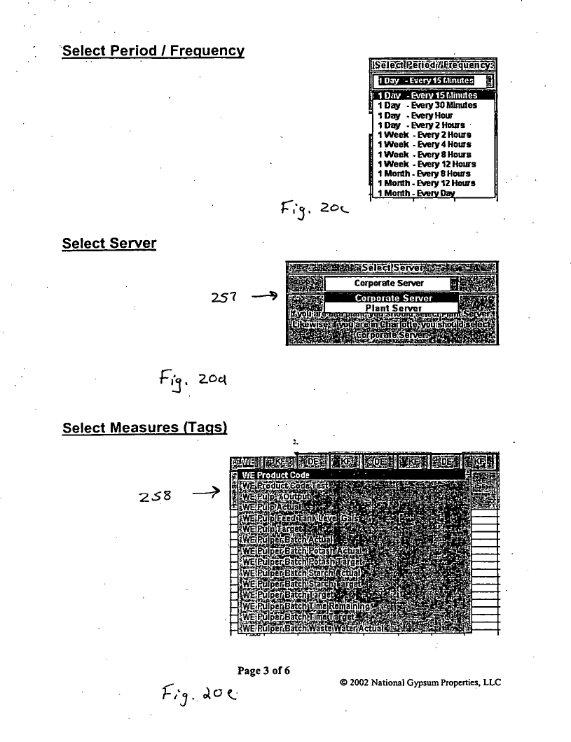

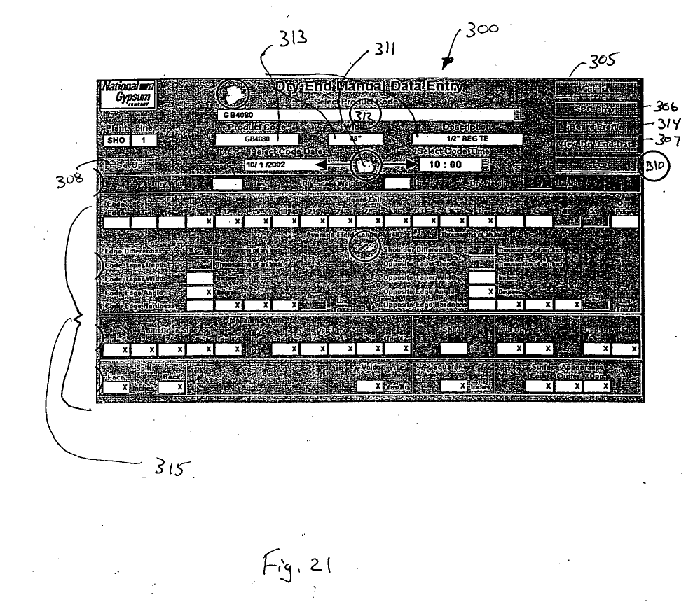

Still referring to FIG. 19, after accessing the Ad Hoc Reporting subsystem, the user will be presented with several dropdown menu boxes that will allow the user to customize a data report. The user will be presented with a starting date dropdown menu 252 and a starting time dropdown menu 253. FIG. 20a shows a screen shot of both the date and time dropdown menus 252 and 253. As shown in FIG. 20a, once a user clicks on the date dropdown menu 252, the user will be presented with a calendar to select a desired day of a desired month. The user can change the month that is being viewed by using scrolling buttons 254. After selecting the date, the user can then select the desired start time by clicking on the time dropdown menu 253. As shown in FIG. 20a, after clicking on the time dropdown menu 253, the user will be presented with each hour for the selected day.

Referring back to FIG. 19, top level screen 250 also has a plant dropdown menu 255 that allows the user to select the desired plant to run the report from. FIG. 20b shows a screen shot of the plant dropdown menu 255. As shown in FIG. 20b, the plant dropdown menu 255 presents the user with all of the plants that are tied into plant management system 10. Further, top level screen 250 also has a period/frequency dropdown menu 256. FIG. 20c shows a screen shot of the period/frequency dropdown menu 256 of the top level screen 250. As shown in FIG. 20c, period/frequency menu 256 allows a user to view the data by different periods of time (i.e., a day, a week, a month, etc.) and that allows the user to select the frequency of the data that is seen during that time period (i.e., every 15 minutes, every hour, every 2 hours, etc.). Top level screen 250 also has a server dropdown menu 257 that allows the user to select the desired server to run the report from. FIG. 20d shows a screen shot of the server select dropdown menu 257. As shown in FIG. 20d, the user can select the server (i.e., the plant server or corporate server) from which the data is retrieved.

Referring back to FIG. 19, the top level screen 250 also allows the user to select the measures of which he and/or she would like the report to contain. In this embodiment, top level screen 250 has 25 measure dropdown menus 258 that each correspond to an independent column. FIG. 20e shows a screen shot of one of the measure dropdown menus 258. As shown in FIG. 20e, the user can click on the down arrow for each of these dropdown menus 258 to select the desired measures to be retrieved from the plant or corporate database. The user can select one measure for each of the twenty-five columns listed in the report. While this embodiment has twenty-five columns and measure dropdown menus, the Ad Hoc Reporting subsystem could be configured to contain any number of measure columns.

Referring back to FIG. 19, once the user has finished configuring the top level screen 250 of the Ad Hoc Reporting subsystem, the user can press the retrieve data button 259 to populate the query. The subsystem will retrieve the values of the measures requested for the selected period of time and frequency, and will calculate the average and the standard deviation of the selected measures. Once the data is retrieved, the user can choose to save the report by clicking on the “save to file” button 260. Scroll buttons 261 are also provided on the top level server to enable the user to scroll back and forth through the data.

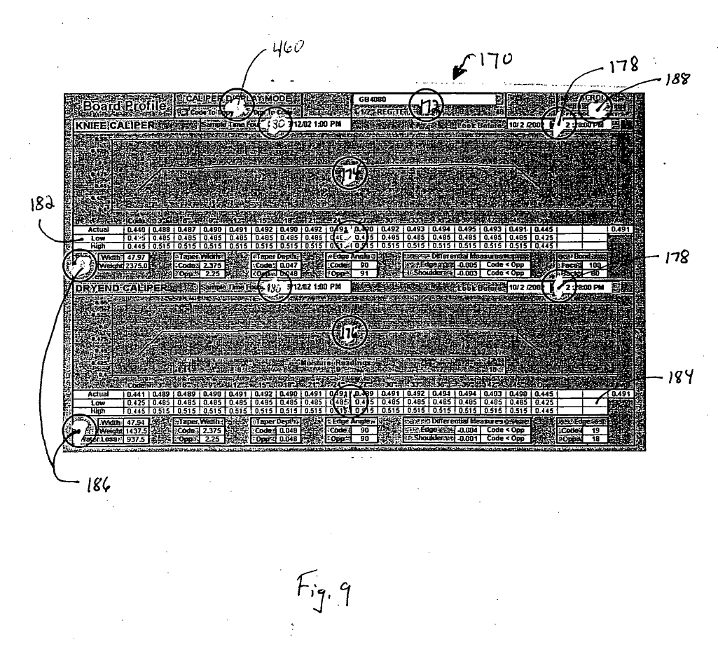

Referring back to FIG. 2a, dropdown menu 48 has a “Board Profile” tab 171. By clicking on the Board Profile tab 171, a user can access a screen that will enable the user to view product specific information. In this embodiment, plant management system 10 is being used to monitor, collect and manipulate data from a wall board manufacturing plant. Thus, this embodiment provides a screen that will enable the user to view the actual profile for any of the produced wall boards. FIG. 9 shows a screen shot of a Board Profile screen 170. As shown in FIG. 9, a user can use dropdown product menu 172 to select the product of which the user would like to view the profile. After selecting the product, Board Profile screen 170 will plot the physical profile of the selected product on a knife caliper chart 174 and a dry end caliper chart 176. Each chart allows the user to select a “look before” date and time in dropdown menus 178. After selecting the “look before” date and time, the system will search the plant database for a sample taken on the chosen product prior to the specified date and time. Window 180 will display the date and time for the first sample found in the plant database that meets the search criteria.

Still referring to FIG. 9, charts 174 and 176 plot the profile of the retrieved sample based on the caliper measures taken for that sample (the y-axis) for each inch of the width of the selected product (the x-axis). The plotted information for the knife caliper chart 174 and dry end caliper chart 176 are also displayed in knife caliper table 182 and dry end caliper table 184, respectively. The physical characteristics and properties of the particular sample are also shown on the Board Profile screen 170 in various property tables 186. In this embodiment, such characteristic and physical properties include, but is not limited to, the width, weight and water loss of the selected board. Board Profile screen 170 also has scroll buttons 188 that allow a user to scroll through all the samples in the plant database that were taken prior to the specified “look before” date. Board Profile screen 170 also allows the user to display the board profiles from the code edge to the opposite edge of the board, or vice versa by selecting one of radio buttons 460.

Referring back to FIG. 2a, dropdown menu 48 has a “Statistics” tab 119. By clicking on Statistics tab 119 or by clicking on the measure buttons 122 on the KPI dashboard 40 (shown in FIG. 2b), a user can access the statistical process control subsystem (“SPC subsystem”) through SPC module 36. The SPC subsystem allows the user to produce control charting and reporting directly from the source plant database. No interfaces or intermediate file structures are needed to generate the desired statistical views of the data from the SPC module 36.

FIG. 10 shows a screen shot of the SPC module 36. As shown in FIG. 10, SPC module 36 has a control toolbar 120 with time and date dropdown menus 121 that allow the user to select the desired date and time for the SPC module to search for a process change. Once the user defines the date and time for the process change, SPC module 36 collects the historical data from the plant database 28 (shown in FIG. 1) and calculates statistics for a specific measure and product to generate a series of points. Each generated point comprises a group of samples of the selected measure taken from the selected product during the manufacturing sub-process. In this embodiment, SPC module 36 utilizes 25 points to calculate the average upper control limit (“UCL”) 123 for the values of the samples, the average lower control limit (“LCL”) 124 for the values of the samples, the average value of these samples (“X2Bar”) 125, the UCL 127 of the range of differences between the sample values, the LCL 126 of the range of differences between the sample values, and the average range (RBar) 117 of differences between the sample values. The control data toolbar 120 displays the number of points used to calculate these statistics and displays the standard deviation 128 for these points. These statistics can be saved for the chosen date and time by clicking on the save button 129 on the control data toolbar 120. Further, a user can select a different time and date, and cause the SPC module 36 to recalculate these statistical values by clicking on the “ReCal” button 130.

Still referring to FIG. 10, SPC module 36 also flags and displays a running count of out-of-control conditions (i.e. points that exceed the UCL or do not reach the LCL) on the error condition display 132. Display 132 can identify the type of errors (i.e. range errors vs. average errors) by using a color to identify the range errors and another color to identify average errors. In this embodiment, average errors appear in blue and range errors appear in green. SPC module 36 generates a chart 135 displaying the average values of the samples for each point over a specific period of time and a chart 136 displaying the range values of the samples for each point over a specific period of time.

Still referring to FIG. 10, SPC module 36 has a chart parameters toolbar 133 that allows the user to select the product code from dropdown product code menu 141 and corresponding manufacturing sub-process measure from dropdown measures menu 137. Further, user can use dropdown menus 138 to select the sample rates for charts 135 and 136, and drop down menu 134 to select the date and end time. Further, the user can select month-to-date data or 3-month data through dropdown menu 145. In this embodiment, the sample rate gives the user the ability to display the system's automatically collected data every 1, 2 or 3 hours. After all these parameters are set, the user can then click on the “Go” button 139 in order to cause SPC module 36 to generate charts 135 and 136. Once the charts are generated, parameters toolbar 133 will display the number of points 142 displayed on each chart and the user can utilize scroll buttons 143 to scroll through the data points. At any time the user wishes, the user can change any one of the parameters and generate a new set of charts by clicking on Go button 139.

Chart 135 displays the average values of the samples taken for each point on the y-axis and the corresponding point number on the x-axis. Chart 136 displays the range value between the lowest sample and highest sample taken for each point on the y-axis and the corresponding point number on the x-axis. The average value and range value is listed for each point in table 144. Table 144 also lists the time/date for each sample that makes up the point, along with the value of each sample. In this embodiment, the samples that make up each point range from three to five. While this embodiment uses three samples to define a point, the system could be programmed to use any number of samples to define a point.

Chart 135 will display the average UCL 123, the average LCL 124 and the X2Bar 125 for the measure selected. Similarly, chart 136 will display the range UCL 127, the range LCL 126 and the RBar 117 for the measure selected. SPC module 36 will plot all the number of points 142 listed in the parameters toolbar 133. Any point that exceeds the average UCL 123 and/or the range UCL 127, or does not reach the average LCL 124 and/or the range LCL 126 will be flagged by out-of-control buttons 148. The user can click on the out-of-control button 148 to be taken to a Reasons and Actions pop-up window 150.

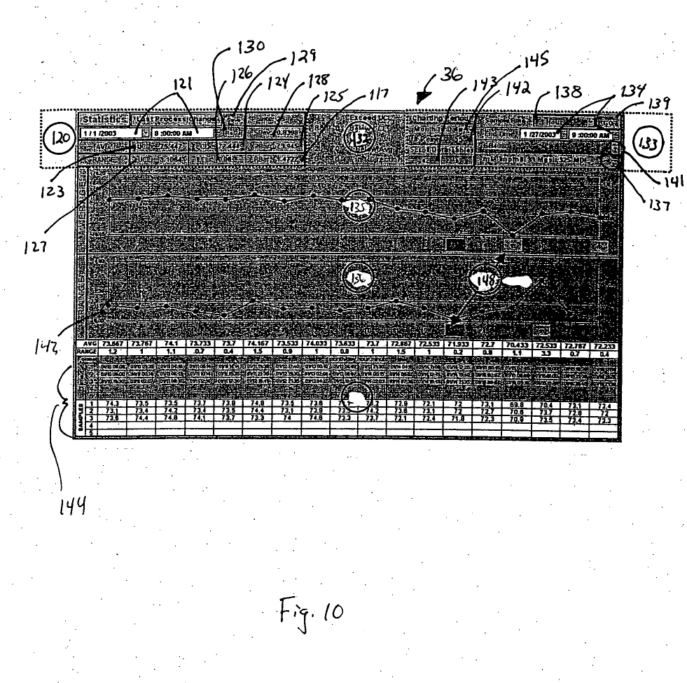

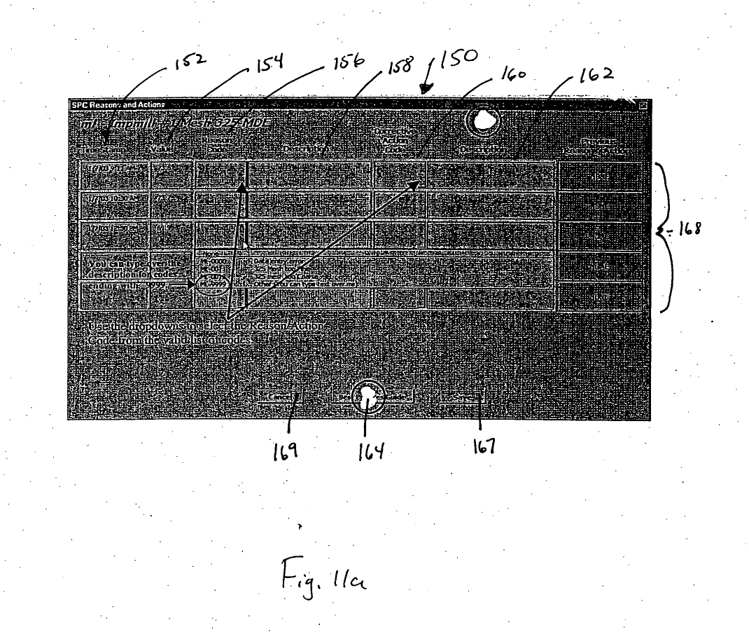

FIG. 11a shows a screen shot of pop-up window 150. As shown in window 150, the window displays a time stamp column 152 that shows the time and date for each sample that defines the out-of-control point, and a value column 154 that shows the value for each sample that defines the out-of-control point. Window 150 has four dropdown menus for each sample displayed. The dropdown reason code menu 156 and corresponding dropdown description menu 158 allow the user to select from several pre-defined reasons for the point being out-of-control. If none of the pre-defined choices explain the reason for the out-of-control point, the user can select an “other code” that allows the user to enter another reason for the discrepancy in dropdown description menu 158. The user is also presented with a corrective action code menu 160 and a corresponding description dropdown menu 162 that allows a user to select from various pre-defined corrective measures taken by the plant to prevent the out-of-control point from occurring again. As with the reason code menu 156, the user can select an “other” code to provide a customized description of a corrective measure taken.

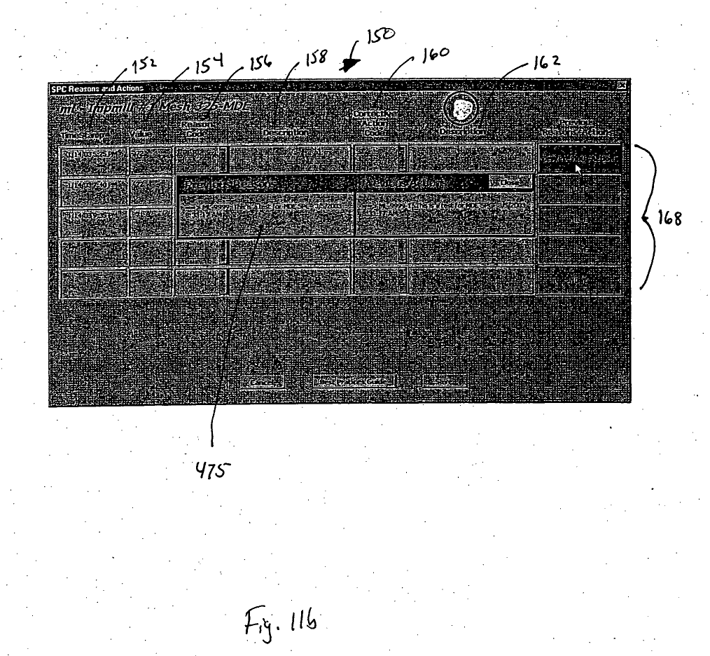

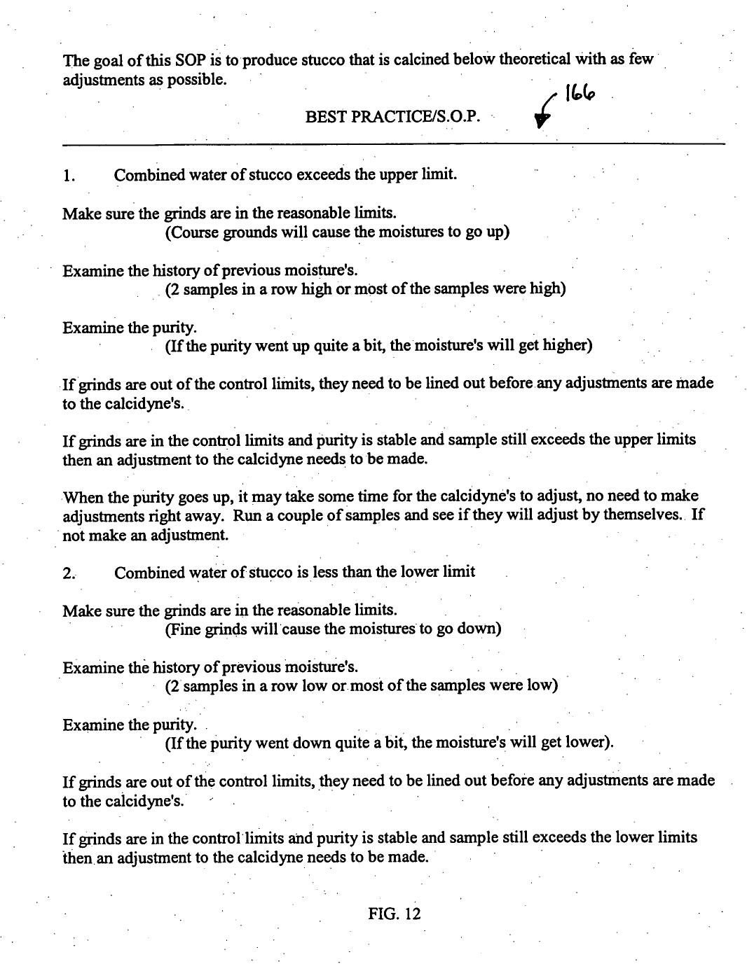

If the user needs assistance in determining what the problem may be and what corrective actions should be taken, window 150 provides a “Best Practices Guide” button 164 that allows the user to access a document that provides diagnostic and preventive guidance (“Best Practices Guide”). Best Practices Guide 166 can also be accessed through dropdown menu 48 (shown in FIG. 2a) by selecting the Best Practices Guide tab 470. FIG. 12 shows a print-out of a sample Best Practices Guide 166. As shown in FIG. 12, Guide 166 provides potential reasons and solutions for specific scenarios that may be encountered during the selected manufacturing process. This will help the user select the proper code and describe the reason for the out-of-control point and the proper code and description of the corrective measure taken. Once the user selects the proper code and description of the reason for the out-of-control point from menus 156 and 158 and the proper code and description of the corrective action taken from menus 160 and 162, the user can save this information in the plant database 28 by clicking on save button 167. If the user does not wish to save this information, the user can hit cancel button 169. Once this information is saved, it can be used to analyze process upsets and effectiveness of corrective actions.

FIG. 11b shows a screen shot of window 150 when information has already been provided for a sample in the particular out-of-control point. As shown in FIG. 11b, window 150 has a column 168 devoted to previous reasons and actions entered into the SPC module 36 by a user. A user can identify whether previous reasons were provided and remedial actions taken by seeing if any of the buttons in column 168 state “view previous actions.” By clicking on a “view previous actions” button, a user can view a pop-up window 475 that details the reason for this out-of-control point and the corrective action taken to ensure that it does not occur again. Referring back to FIG. 10, out-of-control buttons 148 on SPC module 36 can appear in one color to indicate that no reason has been provided as to why this point was outside the control limits, and can appear in another color to indicate that a note has been entered to explain the reason for this point appearing outside the control limits. For example, in this embodiment the out-of-control button 148 appears in yellow if no note has been entered and appears in green if a note has been entered. If a reason has been provided, a user can click on the out-of-control button 148 and be taken to the Reasons and Actions pop-up window 150.

SPC module 36 also provides the user with a SPC Quality Reporting subsystem for creating standard or customized quality reports. The subsystem allows a user to configure a statistical summary for key process measures and product tests. The subsystem can be accessed by opening the “quality report file” (not shown) through the toolbar's 11 dropdown file menu 191 (shown in FIG. 2a). Alternatively, the subsystem can be accessed through a shortcut link on a desktop or laptop computer. In this embodiment, the subsystem has a login screen 192.

FIG. 13 shows a screen shot of login screen 192. As shown in FIG. 13, open file button 194 allows a user to access the SPC Quality Reporting subsystem. Open file button 194 is automatically enabled for users trying to access the subsystem at their own plant. However, if a user desires to enter this subsystem for a different plant or a user of corporate ADC dashboard 32 (shown in FIG. 1) tries to access this subsystem, then open file button is not automatically enabled and requires the user to enter a valid password in login window 189 to access the subsystem. Once the file button 194 is enabled, the user can click on the enabled open file button to access the subsystem. Login screen 192 also shows the default server (corporate or plant) in window 197 for the user and the default plant in window 195. The user can change the server selected if he and/or she desires. Based on the server selected and the plant selected, the login screen will display the specific server identifier in window 199.

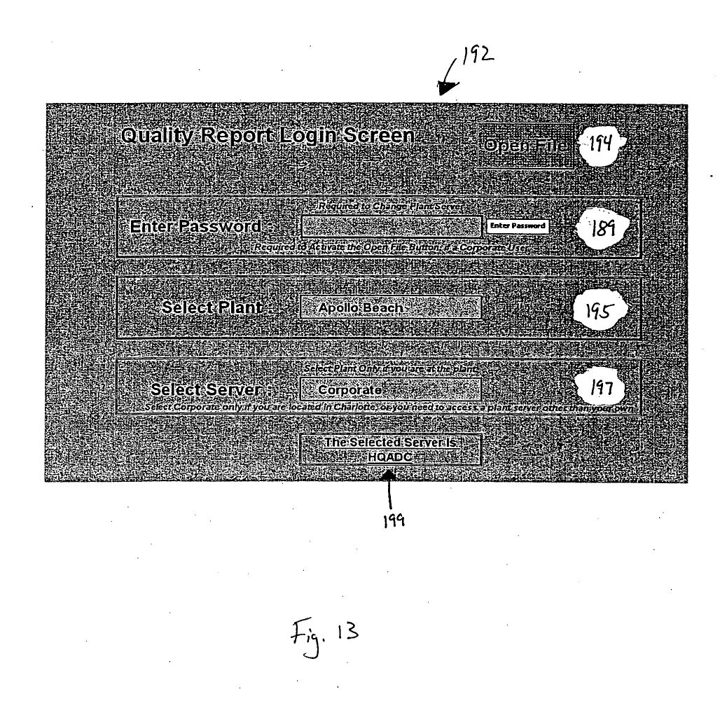

FIG. 14 shows a screen shot of the main menu 193 of the SPC Quality Report subsystem. The subsystem allows a user to configure a statistical summary for key manufacturing sub-process measures and product tests. Such a summary can be used to monitor the current manufacturing sub-process and to analyze the impact of any process changes. As shown in FIG. 14, the plant selected on the login screen is displayed in window 195, the selected server is displayed in window 197 and the specific server identifier is displayed in window 199. A dropdown menu will be enabled for switching between plants and servers if the user was required to and actually had entered a valid password in the login screen 192. The user can utilize dropdown menus 196 to select the desired month and year for the report. In this embodiment, the main menu 193 provides the user with five different dropdown product menus 187 to allow the user to select the desired products to be included in the report. While main menu 193 only allows the user to select up to five products to be included in the report, the main menu could be configured to include any number of products in the report.

Still referring to FIG. 14, once the user selects the plant, the date range and the products for the report, the user can click on retrieve data button 198. The SPC Quality Report subsystem then accesses the plant or corporate database to create a variety of reports. For example, in this embodiment, the subsystem has the ability to produce a Product Detail Report by selecting one of the “Product Details” buttons 210, a Monthly Quality Report by clicking on “Monthly Board Report” button 201, a Monthly Board Weight Report by clicking on “Monthly Board Weight Report” button 213 and a Monthly Mill Report by clicking on “Monthly Mill Report” button 215. Further, a user can access a Product Data Screen by clicking on “Set-Up” button 206.

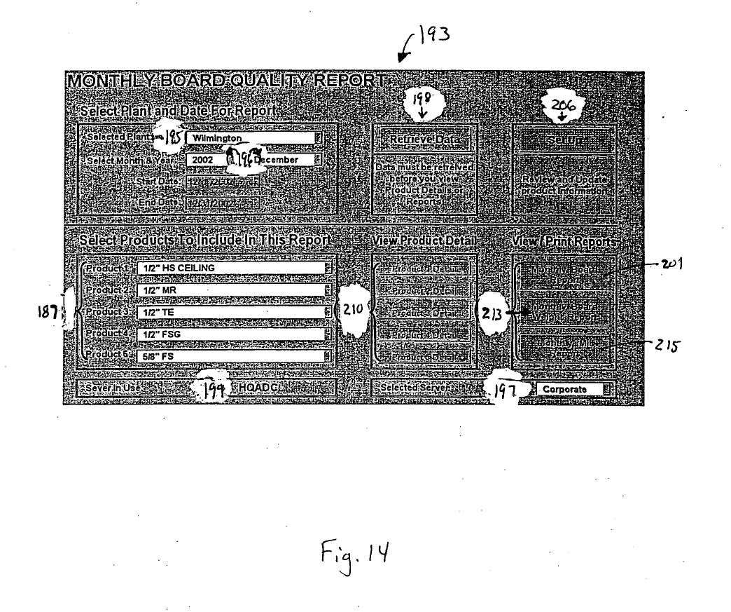

FIG. 15 shows a sample Monthly Quality Report 200 generated by the SPC Quality Report subsystem for a specific plant when a user clicks the “Monthly Board Report” button 201. As can be seen in FIG. 15, this Report 200 provides five tables for each of the selected products 401 that addresses the selected measures. For this report 200, the user selected the nail pull, core hardness, edge hardness-code, edge hardness-opposite code, and end hardness measures to view for the five selected products. For each selected measure and product, the report displays the test location 402 (e.g., Lab), the number of samples tested, the manufacturing process limits, the 3 month rolling average, the standard deviation, the prior year-to-date average, the prior year average, the Cpk, the estimated defects per 1,000 units and the Cp. While report 200 shows only five products, only five measures, and the above-referenced data, the report can be customized to show any number of products, any number of measures or any number calculations and data. Once generated, these reports can be electronically saved by clicking on the “save as file” button (not pictured) or the user can choose to discard the report and return to the main menu 193 of the subsystem by clicking on the “return” button (not pictured).

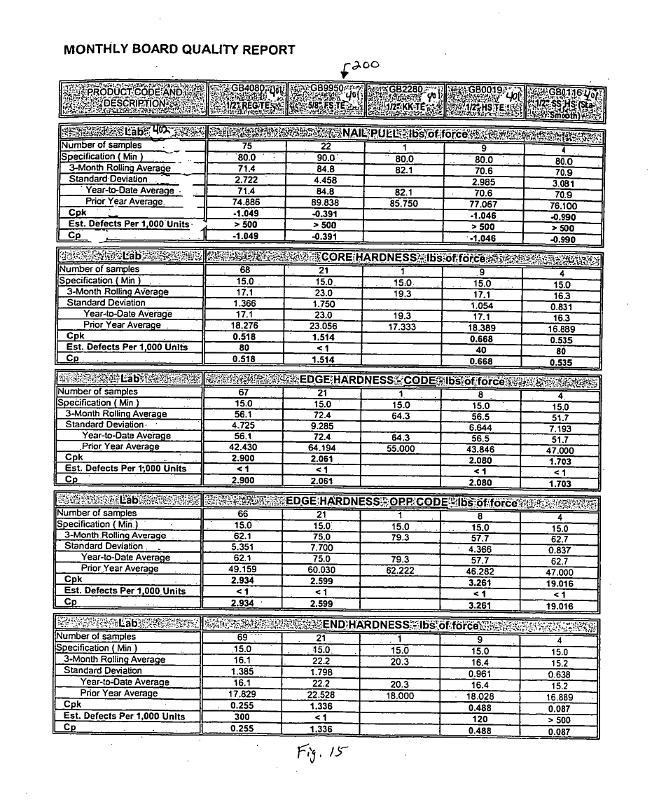

Referring back to FIG. 14, the user can generate a Monthly Board Weight Report by selecting Monthly Board Report Button 213. FIG. 16 shows a screen shot of Monthly Board Weight Report 214 that identifies the plant and month for which the report was generated. This report lists by month the total monthly average weight, the total standard deviation and the total number of samples taken for the five products selected on main menu 193 of the subsystem. The user can select to save this report by clicking on “save as” button 430 or return to main menu 193 by clicking on return button 431. While two types of reports generated by the SPC Quality Report subsystem are described herein, the subsystem can generate any number of desired reports from the data stored in the plant database 28 and/or corporate database 26 that meets the specific needs of the plant utilizing the subsystem.

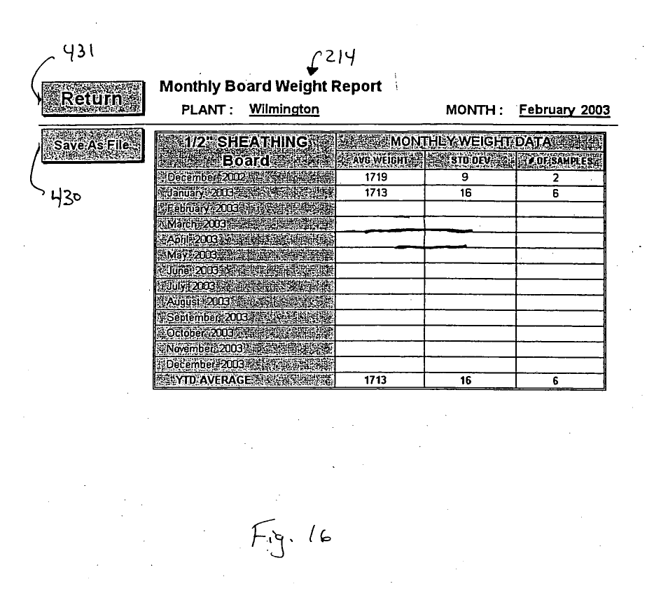

Referring back to FIG. 14, the user can also review and update information for all the products by clicking on the “Set-up” button 206. FIG. 17 shows a screen shot of a Product Data screen 208 for all of the products. As shown in FIG. 17, Product Data screen 208 allows the user to assign a PLC value 405 to each of the products. In this embodiment, the PLC value 405 ranges from 1-100 with each PLC value representing the PLC 12 (shown in FIG. 1) that gathers data for a specific product produced by a manufacturing sub-process. The user can place a description 406 for each product next to the PLC value that is assigned to the product. For the wallboards of this embodiment, this product descriptions starts with the caliper measure and is followed by the board type. The product code 407 is then typed in for that product. In this embodiment, the product code 407 is the catalog number assigned to each product. Further, screen 208 specifies the width 408 for each product. The rest of the columns of this chart correspond to the standard information 409 (i.e., standard speed, standard dry weight, standard water loss) that may appear on Report 200 (shown in FIG. 15). Once the user is done updating and/or reviewing this product information, the user can hit return button 204 to return to the main menu 193 of the subsystem.

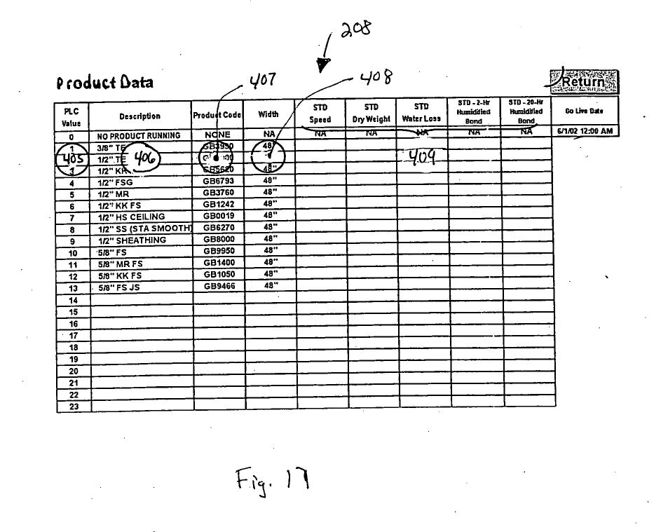

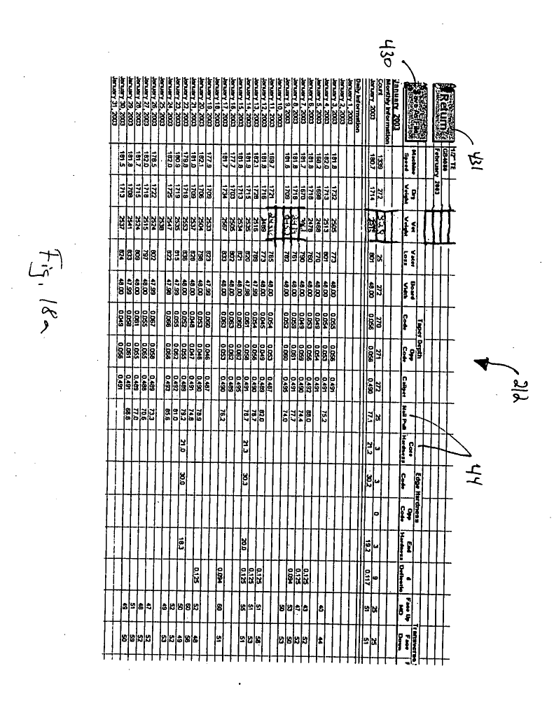

Referring back to FIG. 14, after the SPC Quality Reporting subsystem has retrieved the requested data, the user can view detailed information regarding each of the selected products by clicking on the corresponding Product Detail button 210 to access a Product Detail Report 212. FIG. 18a shows a screen shot of Product Detail Report 212. As shown in FIG. 18a, the Product Detail Report 212 displays all the detailed information for each measure 44 of the selected product that is used to create Monthly Board Quality Report 200. In this embodiment, the Product Detail Report 212 provides monthly totals and averages, as well as, daily averages for every sample tested during the current month and each of the prior two months. A user can utilize scroll bars (not pictured) to scroll left and right to view all the measures that were recorded and to scroll up and down to view each month's data. The user can save the file by clicking on the “save as” button 430 or can choose to return to the main menu 193 of the subsystem by clicking on the “return” button 431.

By scrolling far enough down the user can see further information regarding the product as well. For example, FIG. 18b shows a screen shot of the 3-month rolling average section 420 of the Product Details Report 212. Section 420 displays the average and number of samples for the rolling three month period. Further, FIG. 18b shows a 3-month period ending section 421 of Product Details Report 212. Section 421 displays the three month rolling average for each month of the year (i.e. January shows the average for November-January, February shows the average for December-February, etc.). Moreover, FIG. 18c shows a screen shot of the current year-to-date averages 422 of Product Details Report 212 and monthly averages 423 of Product Details Report 212 for all samples tested. The SPC Quality Reporting subsystem obtains this information from the plant or corporate database and calculates the desired information using standard formulas. If for any reason the reported data is inaccurate, the user can overwrite the reported data in section 424.

Referring back to FIG. 1, ADC dashboard is connected in a network to a QTDE subsystem 38. QTDE subsystem 38 allows plant floor operators and lab technicians to manually enter product test data/measures directly into the plant database 28. The specific tests to be entered can be tailored to meet the manufacturer's requirements. By storing product test data on the plant database, the user can access the results of the product testing through the ADC dashboard and utilize the data for all the dashboards, reports, modules and subsystems described above. Further, the data collected by the PLCs 12 can be directly linked with these tests of the finished product to support problem solving and continuous improvement effort.

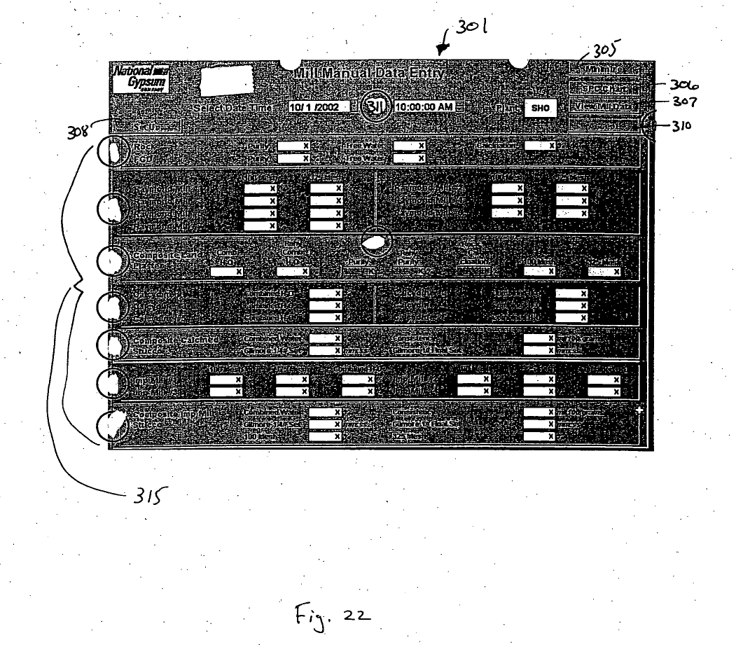

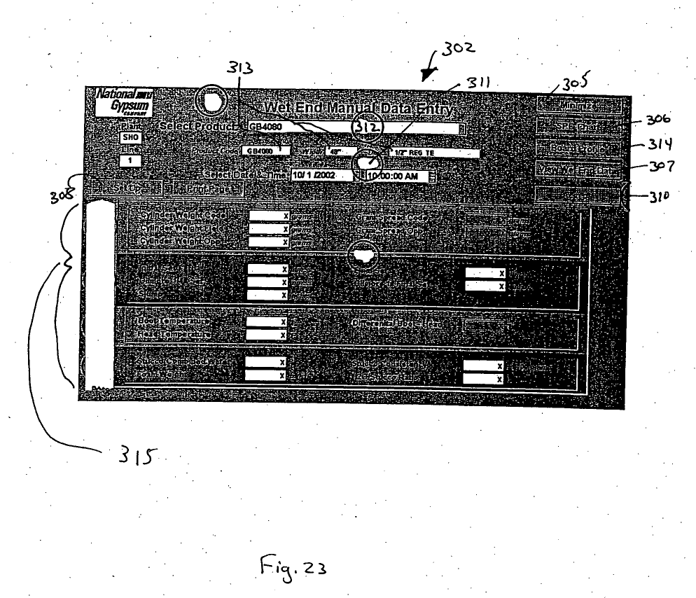

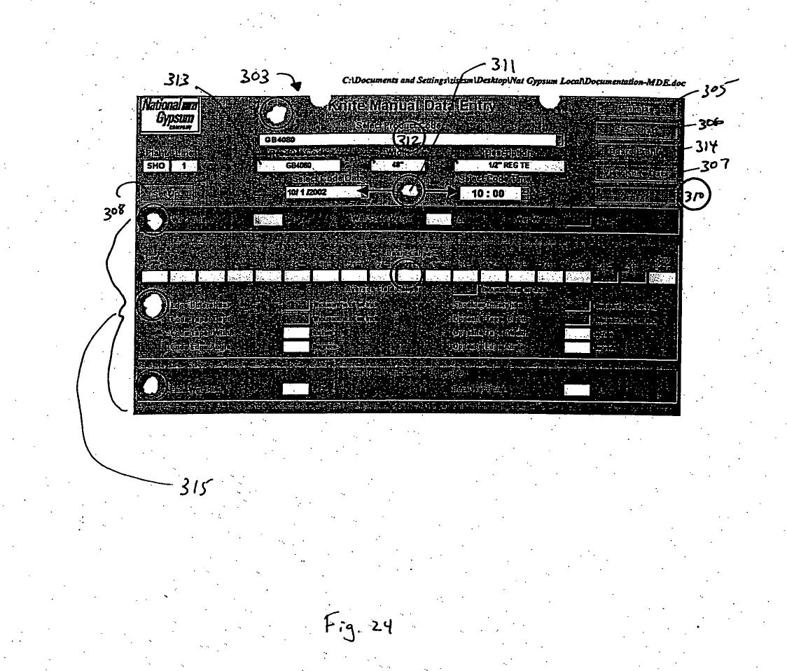

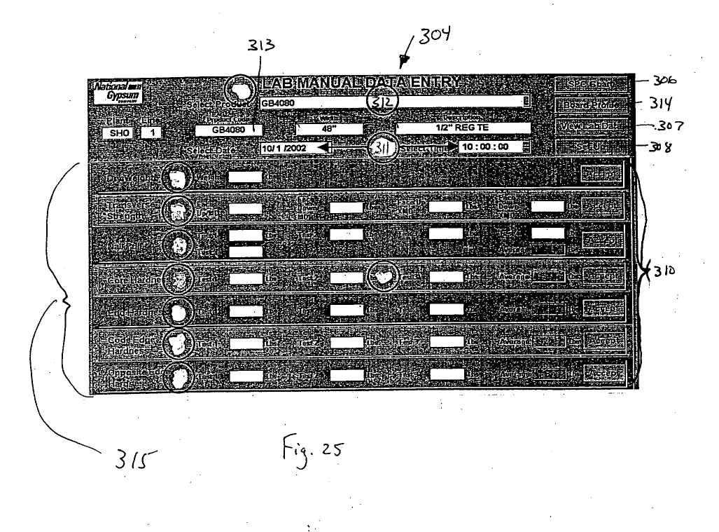

FIGS. 21-25 shows sample data entry screens for the QTDE subsystem 38. All of the QTDE subsystem's 38 data entry screens have some common characteristics and features. For example, each data entry screen is identified by a title. FIG. 21 shows a screen shot of a Dry End Manual Data Entry screen 300. FIG. 22 shows a screen shot of a Mill Manual Data Entry screen 301. FIG. 23 shows a screen shot of a Wet End Manual Data Entry screen 302. FIG. 24 shows a screen shot of a Knife Manual Data Entry screen 303. FIG. 25 shows a screen shot of a Lab Manual Data Entry Screen 304

All of the data entry screens (shown in FIGS. 21-25) of this embodiment have common buttons and features. Except for Lab Manual Data Entry Screen 304, the data entry screens each have a minimization button 305 that allows the user to minimize the screen to work on other applications. All the data entry screens 300-304 have a SPC chart button 306 that allows the user to access the SPC module 36. The data entry screens also have a view data button 307 that allows the user to access a view data screen with the same layout as the data entry screens. The view data screen allows the user to scroll through all the gathered data. Moreover, the data entry screens have a set up button 308 that allows the user to access a file containing the product and plant information and an accept button 310 that becomes enabled once data has been entered. Once the user hits the accept button 310, the data is entered directly into the plant database 28 and the data is then cleared from the data entry screen. The data entry screens of FIGS. 21-25 also have date and time dropdown menus 311 that allow the user to select the date and time for when the data was collected. For the Mill and Wet End Manual Data Entry screens 301 and 302, respectively, the selected date and time identifies when the sample was taken. In contrast, for the Dry End, Knife and Lab Manual Data Entry screens, 300, 303 and 304, respectively, the date and time refers to the date and time coded on the board being tested.

All of the data entry screens, except for the Mill Manual Data Entry screen 301, also have a select product dropdown menu 312 that allows the user to select the product being tested. Further, all of the data entry screens, except for screen 301, identify the product code, width and description of the selected product in windows 313. Moreover, these data entry screens also have a board profile button 314 that allows the user to access board profile 70 for the selected product. All of the screens 300-304 have fields 315 that allow the user to enter in the desired test results into the data entry sheet.

In operation, the user performs the desired test and enters all the resulting data into the desired fields 315 of the screens 300-304. As the data is entered into a manual data entry sheet, each field is validated with the QTDE subsystem 38, to ensure that obvious data entry errors are prevented by making sure the data entered falls within a specific range. If the data is outside the validation range, a pop-up screen will be displayed asking if the information is indeed correct. Further, the data entered will also be validated by the SPC subsystem. Thus, when the accept button is pressed, each measure/piece of data will be checked against the UCLs and LCLs set for that data in the SPC module 36 (shown in FIG. 10). If one or more of the manually entered measures/pieces of data fall outside the UCLs and LCLs, the user will automatically be transferred to the SPC subsystem and be prompted to fill out one of the Reasons and Actions pop-window 150 in order to explain the cause of the out-of-control point and the corrective action taken. Once the data is entered into the desired fields, the accept button will be enabled and the user can hit the accept button to enter the data into the appropriate database 26 and/or 28.

Thus, among other things, the described embodiment of the present invention is a system and method that generates customizable, real time reports for plant personnel. It eliminates the multiple data entry points through the collection of the PLC data, the HMI data and the data entered through the QTDE subsystem 38 in the plant and/or corporate database. Moreover, this embodiment allows plant personnel to easily and quickly configure the system to the plant by providing the KPI platform 40. KPI platform 40 allows an end-user to set alarms and specification values for each product through the Update Alarms and Specifications screen 46 and allows an end-user to input information specific to the plant and the manufactured products through the Product and Information screen 60.

This embodiment allows an end-user to configure customized views of the plant manufacturing process data through the generation of reports through the KPI platform 40, the Ad Hoc Reporting Subsystem, and the SPC module 36. Further, it alerts a user (i.e., plant personnel) in real time through SPC module 36 when a manufacturing system is approaching the specification limit (i.e., an alarm) and when the manufacturing process has exceeded the specification. While this summarizes some of the benefits of this embodiment of the plant management system and method, the present invention has many more benefits that have been outlined herein.

While the present invention has been described in detail with reference to certain exemplary embodiments thereof, such description is offered by way of non-limiting example of the invention, as other versions are possible. It is anticipated that a variety of other modifications and changes will be apparent to those having ordinary skill in the art and that such modifications and changes are intended to be encompassed within the spirit and scope of the invention as defined by the following claims.

1. A method of monitoring a manufacturing sub-process, the method comprising the steps of:
a) providing a KPI platform with a SPC subsystem;
b) collecting and storing at least one piece of data in at least one database through at least one data collecting apparatus;
c) setting at least one range of specifications for the at least one piece of data on the KPI dashboard;
d) accessing the single database with the KPI dashboard; and
e) notifying at least one user through the SPC subsystem in real time when the at least one piece of data falls outside the at least one range of specifications.

2. The method of claim 1, wherein the collecting and storing at least one piece of data step comprises automatically collecting and storing a first piece of data in the at least one database and manually collecting and storing a second piece of data in the same at least one database.

3. The method of claim 1, further comprising the step of storing at least one piece of product identifying data and at least one piece of manufacturing plant specific data together in the at least one database.

4. The method of claim 1, further comprising the step of allowing the user to select at least one manufacturing sub-process through the KPI dashboard.

5. The method of claim 3, wherein the collecting and storing at least one piece of data step collects and stores at least one measure specific to the at least one selected manufacturing sub-process.

6. The method of claim 4, wherein the setting at least one range of specifications step comprises setting at least one range of specifications for the at least one measure.

7. The method of claim 5, further comprising the step of setting at least one alarm within the range of specifications for the selected manufacturing sub-process.

8. The method of claim 6, further comprising the step of notifying the user in real time when the at least one collected measure triggers the alarm.

9. The method of claim 8, further comprising the step of entering into the at least one database a reason for the collected measure triggering the alarm.

10. The method of claim 9, further comprising the step of entering a corrective action in the at least one database that was taken to prevent the at least one measure from triggering the alarm again.

11. The method of claim 1, further comprising the step of generating at least one report based on the at least one piece of data stored in the at least one database.

12. A method of monitoring at least one manufacturing process for at least one manufacturing plant, the method comprising the steps of:
a) entering at least one piece of product identifying data for at least one product into a first data entry field;
b) entering at least one piece of manufacturing plant specific data into a second data entry field;
c) assigning at least one data collecting apparatus to at least one manufacturing sub-process that produces the at least one product;
d) collecting at least one piece of process data with the at least one collecting data apparatus; and
e) storing the product identifying data, the plant specific data and the process data together in at least one database.

13. The method of claim 12, further comprising the step of manually collecting at least one piece of product data from the at least one product and entering the data in the same at least one database that stores the product identifying data, the plant specific data and the process data.

14. The method of claim 12, further comprising the step of setting at least one range of specifications for the at least one piece of process data.

15. The method of claim 14, further comprising the step of notifying the user in real time when the at least one piece of process data falls outside the at least one range of specifications.

16. The method of claim 14, further comprising the step of setting an alarm within the at least one range of specifications.

17. The method of claim 16, further comprising the step of notifying the user in real time when the at least one piece of process data triggers the alarm.

18. The method of claim 13, further comprising the step of generating at least one report from the at least one piece of product identifying data, the at least one piece of plant specific data, the at least one piece of process data, and the at least one piece of product data stored in the same at least one database.

19. The method of claim 12, further comprising the step of allowing at least one user to access the at least one database in order to track the at least one product through each step of the at least one manufacturing sub-process.

20. A method of allowing a user to directly access a plant management database and configure and manipulate the data stored therein, the method comprising:
a) providing at least one piece of manufacturing equipment capable of producing at least one product;
b) collecting automatically at least one piece of process data from the at least one piece of manufacturing equipment;
c) entering manually at least one piece of product data for the at least one product produced from the manufacturing equipment; and
d) storing the at least one piece of process data and at least one piece of product data together in the same at least one database.

21. The method of claim 20, further comprising the step of setting at least one range of specifications for the at least one piece of process data.

22. The method of claim 21, further comprising the step of notifying the user in real time when the at least one piece of process data falls outside the at least one range of specifications.

23. The method of claim 21, further comprising the step of setting an alarm within the at least one range of specifications.

24. The method of claim 23, further comprising the step of notifying the user in real time when the at least one piece of process data triggers the alarm.

25. The method of claim 20, further comprising the step of generating at least one report based on the process data and product data stored in the at least one database.

26. A plant management system comprising:
a) at least one piece of manufacturing equipment;
b) a means for gathering at least one piece of process data from the manufacturing equipment;
c) a means for storing the at least one piece of process data in at least one database;
d) a means for manually entering at least one piece of product data into the same at least one database; and
e) a means for allowing a user to access the product and process data to generate at least one report.

27. The plant management system of claim 26, further comprising a means for setting a range of specifications for the process data and product data.

28. The plant management system of claim 27, further comprising a means for notifying the user in real time when the process data and product data fall outside the range of specifications.
